(19) United States
(12) Patent Application Publication
(10) Pub. No.: US 2010/0164966 A1
(43) Pub. Date: Jul. 1, 2010

(54) TIMING CONTROLLER FOR GRAPHICS SYSTEM

(75) Inventor: Kapil V. Sakariya, Sunnyvale, CA (US)

Correspondence Address: DORSEY & WHITNEY LLP;on behalf of APPLE, INC., 370 SEVENTEENTH ST., SUITE 4700, DENVER, CO, 80202-5647, US

(73) Assignee: Apple Inc., Cupertino, CA (US)

(21) Appl. No.: 12/347,491

(22) Filed: Dec. 31, 2008

(51) Int. Cl. G06F 13/14

(52) U.S. Cl. 345/520

(57) ABSTRACT

One embodiment takes the form of an apparatus for changing a frequency of an image data stream, including: a timing controller; a buffer operably connected to the timing controller; wherein the buffer accepts the image data stream at a first frequency; the buffer transmits the image data stream to the timing controller; and the timing controller outputs the image data stream at a second frequency that is lower than the first frequency. In such an embodiment, the image data stream may include a blanking interval; and a data portion; wherein the buffer removes or reduces the blanking interval from the image data stream; and the buffer adjusts the frequency of the data portion such that the data portion and reduced blanking interval occupy a time equal to that of the blanking interval plus the data portion prior to adjustment.

### BACKGROUND OF THE INVENTION

### Related Applications

This application is related to, and incorporates by reference, the following applications: “Timing Controller Capable of Switching Between Graphics Processing Units,” filed on the same date as this application and identified as attorney docket no. P7022US1 (191005/US); “Improved Switch for Graphics Processing Units,” filed on the same date as this application and identified as attorney docket no. P7023US1 (191006/US); and “Display System With Improved Graphics Abilities While Switching Graphics Processing Units,” filed on the same date as this application and identified as attorney docket no. P7024US1 (191007/US).

### TECHNICAL FIELD

Embodiments relate generally to timing controllers associated with graphics processing devices, and more particularly to a timing controller capable of adjusting a frequency of image data.

### BACKGROUND

Electronic devices are ubiquitous in society and can be found in everything from wristwatches to computers. The complexity and sophistication of these electronic devices usually increase with each generation, and as a result, newer electronic devices often include greater graphics capabilities their predecessors. For example, display devices associated with electronic components have become more sophisticated, permitting display of information at higher resolutions and faster refresh rates.

Although this increased sophistication permits display of increasingly complex or fine images, it generally requires that the timing, formatting, processing and other electronics necessary to render the image on the display increase in complexity as well. As one example, the operating rate of such display electronics, with respect to receiving and outputting image data, increases as the resolution of the display and/or the refresh rate of the display becomes greater. Further, these display electronics must be capable of functioning at a maximum operating rate that may be achieved by the display, even when operating at a relatively low signal rate that may be preferred or set by a user or manufacturer. Typically, although not necessarily, the image data is digital.

Although the display electronics may be capable of operating at the necessary rates, it may be more cost-effective to employ electronic components that operate at a lower maximum frequency. Similarly, it may be more fault tolerant to employ electronic components in a display that operate at a lower maximum frequency. In addition, the life of such components may be longer than those having higher operating specifications.

### SUMMARY

One embodiment takes the form of an apparatus for changing a frequency of an image data stream, including: a timing controller; a buffer operably connected to the timing controller; wherein the buffer accepts the image data stream at a first frequency; the buffer transmits the image data stream to the timing controller; and the timing controller outputs the image data stream at a second frequency that is lower than the first frequency. In such an embodiment, the image data stream may include a blanking interval; and a data portion; wherein the buffer removes or reduces the blanking interval from the image data stream; and the buffer adjusts the frequency of the data portion such that the data portion and reduced blanking interval occupy a time equal to that of the blanking interval plus the data portion prior to adjustment.

Another embodiment may take the form of a method for adjusting a frequency of a digital data stream, including the operations of: receiving the digital data stream at a first frequency; storing at least a portion of the digital data stream; determining an initial length of the digital data stream; determining a portion of the digital data stream containing no data; separating the digital data stream into a portion containing no data and a remainder of the digital data stream; expanding the remainder of the digital data stream to fit the initial length by lowering the frequency of the remainder of the digital data stream to a lowered frequency; and outputting the remainder of the digital data stream, without the portion of the digital data stream containing no data, at the lowered frequency as an outputted data stream. In such a method, the portion containing no data may be a blanking interval, such as a horizontal blanking interval or a vertical blanking interval, while the remainder of the digital data stream may be image data.

### BRIEF DESCRIPTION OF THE DRAWINGS

FIG. 1 depicts a first display panel, timing controller and computing system.

FIG. 2 depicts a display panel, timing controller and computing system similar to that of FIG. 1, but including an additional buffer.

FIG. 3 is a timing diagram depicting a sample relationship between raw image data and processed image data.

### DETAILED DESCRIPTION

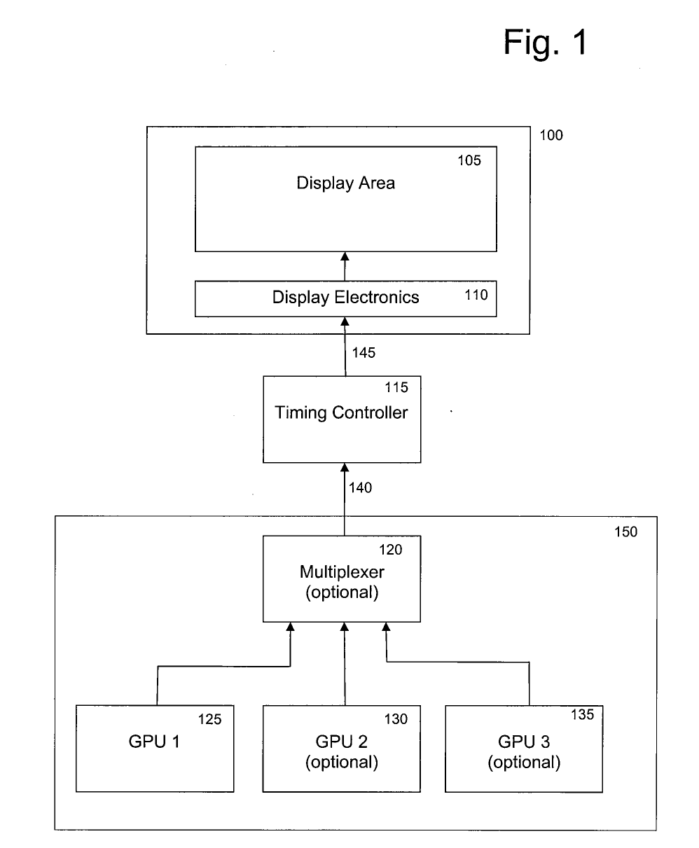

FIG. 1 depicts a display device 100 connected to a computing system 150. As used herein, the term “computing system” embraces any electronic device capable of outputting image data for display on a display device. For example, a desktop or notebook computer, multimedia playback device (e.g., MP3 player, portable digital versatile disc player, portable audiovisual player and so on), mobile telephone, handheld personal digital device (such as a BLACKBERRY, TREO or other personal digital assistant), and so on are all computing systems within the meaning of the term herein and scope of the present document. Likewise, a “display device” is any device capable of rendering and/or displaying image data received from the computing system, with or without intermediate processing or formatting of the graphical information. Accordingly, analog displays such as cathode ray tubes are display devices, as are digital displays such as liquid crystal displays, light-emitting diode (LED) displays, organic LED displays, and so on. It should also be noted that “image data” may include text, graphics, video, and so forth.

The computing system 150 may include multiple graphics processing units (GPUs) 125, 130, 135 or may include only a single GPU. Each GPU 125, 130, 135 generally outputs image data ultimately to be shown in a display area 105 of the display device 100. This image data may be outputted from a GPU on a line-by-line basis. In some embodiments, each line corresponds to a row of the display area 105 in the display device 100. That is, if the resolution of the display area 105 is 1980 by 1050 pixels, the display device 100 supports 1050 separate, distinct lines or rows of image data. Further, each such line outputted by the GPU 125 generally contains data for each pixel in the line. Thus, continuing the present example, the GPU may output 1980 individual pixel data values for each line, since the display area supports a resolution of 1980 columns by 1050 rows, thus yielding 1980 pixels in each row.

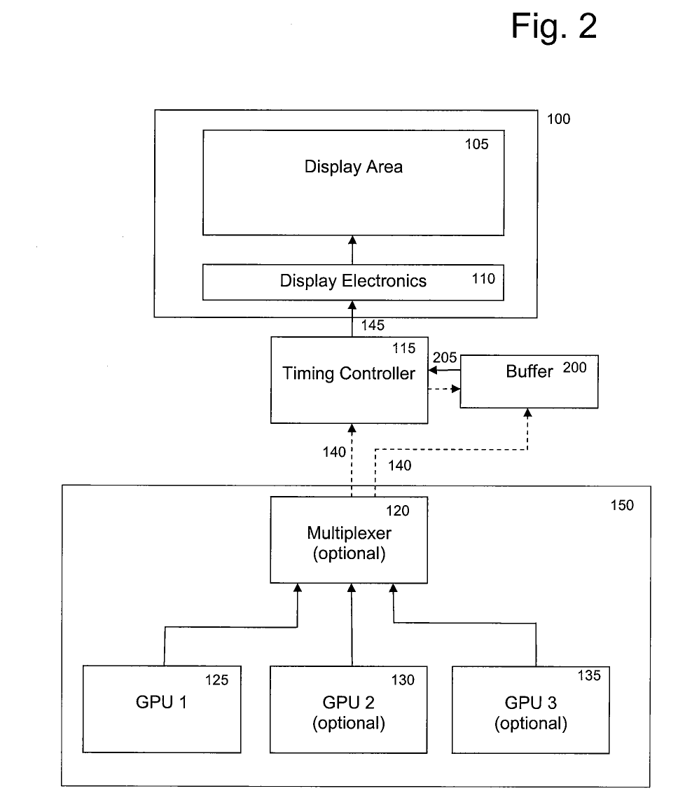

It should be noted that the number of lines outputted by the GPU 125, as well as the number of pixel data packets on each such line, may not match the resolution to which the display area 105 is set. In such cases, the image data may be reformatted by a timing controller 115 associated with the display 100 or the computing system 150. Alternatively, the timing controller may be a separate component placed in-line between the computing system and display. (In FIGS. 1 and 2, the timing controller 115 is shown as separate from both the display 100 and computing system 150 purely as a matter of convenience.) The timing controller 115 may, as necessary, reformat and/or otherwise process the image data received from the GPU 125, 130, 135 to match the resolution of the display area 105. The timing controller is generally responsible for ensuring the image data received from a GPU is properly processed for receipt and display on the display device 100. This may include, for example, adjusting or syncing a timing of the GPU image data signal to a refresh rate of the display device. Such processing may further include determining where a vertical blanking interval (VBI) and/or horizontal blanking interval (HBI) occur. Thus, the timing controller 115 may receive raw image data 140 from a GPU (or optional multiplexer 120, as described in more detail below) and output processed image data 145.

As known to those skilled in the art, an HBI signals the end of each line of data. Thus, generally speaking one HBI occurs between every two adjacent lines of image data. The time interval, and thus the length, of the HBI may vary but generally may not drop below a minimum time.

Likewise, the VBI generally signals the end of a frame of image data and thus occurs between the last line of a first frame and the first line of a second frame. In certain embodiments, both a VBI and HBI may be present at the end of the last line of image data. In other embodiments, the HBI may be omitted since the VBI signals the end of a data frame and thus, inherently, the end of the last line of the frame.

A “frame” of image data is the set of image data necessary to draw every line of the display area 105 of the display device 100. Thus, if viewed alone, a single frame of image data would include all images shown in the display area 105 between refreshes.

Still with respect to FIG. 1, it can be seen that display electronics 110 are part of the display device 100. Generally, these display electronics 110 receive processed image data 145 from the timing controller and output it in the display area 105 of the display device 100. In some embodiments, the timing controller 115 may be integrated into the display electronics 110.

The display electronics 110 generally consist of multiple column and gate drivers Activating a particular gate driver selects the row to be written to or programmed with the image data. Accordingly, for a given line of formatted image data 145 received from a timing controller 115, a single gate driver may be activated and all column drivers are activated simultaneously so that the image data is written to the pixels of the corresponding row, from left to right. (In some embodiments, the column drivers are activated sequentially.) After an HBI, the next gate driver is activated and all column drivers are again activated to write to the pixels of the next corresponding row. After the last row is written to, the VBI occurs to signal the end of a frame. The first gate driver is then activated, so that the next line of image data is written to the first (typically topmost) row of the display area 105 to begin the next frame. This process of sequentially writing to all rows of the display area is performed multiple times every second to refresh images in the display area and/or to prevent image decay. For example, if the refresh rate of the display area 105 or display device 100 is 60 Hz, the process occurs 60 times per second.

Typically, each pixel of image data is transmitted by the GPU at a particular frequency, referred to herein as the “native frequency.” The native frequency of any given embodiment may be calculated as follows:

Native frequency (THP+HBI)×(TVP+VBI)×RR

In the foregoing calculation: THP is the total number of horizontal pixels (e.g., the number of columns of resolution of the display area 105); HBI is the length of the horizontal blanking interval, expressed in a number of pixels; TVP is the total number of vertical pixels (e.g., the number of rows of resolution of the display area); VBI is the length of the horizontal blanking interval, expressed in a number lines of resolution; and RR is the refresh rate of the display device 100. This calculation presumes that one pixel of data is transmitted during each clock cycle of the GPU output. Thus, given a display resolution of 1920 by 1200 pixels and a 60 Hz refresh rate, the native frequency of the raw image data is:

(1920+184)×(1200+51)×60=157.9 MHz.

With respect to the foregoing, it should be noted that current Video Electronics Standards Association (VESA) blanking requirements at a 1920 by 1200 resolution are 184 pixels fOr the HBI and 51 lines for the VBI. VESA blanking requirements for the HBI and/or VBI may vary with the resolution of the display area 105.

Insofar as the native frequency may change with the resolution selected for the display area 105, the timing controller 115 and display electronics 110 generally should configured to accept image data at a number of frequencies. However, as the native frequency of the image data increases, the complexity of the timing controller and display electronics likewise may increase.

As previously mentioned, certain embodiments may include multiple GPUs 125, 130, 135, each of which may transmit data to the timing controller 115 (and ultimately the display device 100) at different times. Typically, only one GPU transmits raw image data 140 to the timing controller to be processed into processed image data 145. By allowing only one GPU to interface with the timing controller at any given moment, video corruption due to conflicting image data may be avoided or reduced.

In such embodiments, a multiplexer 120 may receive raw image data from one or more GPUs 125, 130, 135 and handle switching between GPUs as necessary. Such switching is described in more detail in the applications incorporated by reference herein and set forth above. In embodiments having a single GPU in communication with the timing controller 115, the multiplexer may be omitted.

FIG. 2 depicts an embodiment permitting a timing controller to transmit processed image data 145 at a lower frequency than the native frequency of raw image data 140. The computing system 150, timing controller 115, display 100 and other elements shown in FIG. 2 generally mirror that of FIG. 1 but also include a buffer 200. The buffer 200 may be implemented in the timing controller, the computing system, the display or as a separate electronic component. In many cases, the buffer 200 is integrated with the timing controller 115. It should be noted that this buffer is generally used to store an entire line or frame of image data, as described in more detail herein.

In the embodiment of FIG. 2, raw image data 140 is transmitted from the GPU 125 (if the multiplexer is absent) or the multiplexer 120 to the buffer 200. For purposes of simplicity, presume a single GPU 125 is in communication with the timing controller 115 and no multiplexer 120 is required or present. The operations described herein nonetheless will apply in embodiments having a multiplexer and/or multiple GPUs.

In the embodiment of FIG. 2, raw image data 140 is transmitted from the GPU 125 to either the timing controller 115 or buffer 200, where it is accepted via an input compatible with the GPU's output. The dashed lines of FIG. 2 indicate these alternative paths of communication. Typically, raw image data is transmitted along only one of these paths. If the raw image data 140 is received by the timing controller 115 from the GPU 125, the timing controller will relay that data to the buffer 200 (again, as shown by the dashed line). In many embodiments, the buffer is implemeted within or as a part of the timing controller.

The buffer 200 may be a line buffer, a frame buffer or both. By using an appropriate buffer 200, the HBI and/or VBI may be reduced or eliminated, thus permitting the raw image data 140 to be spread out across the time interval formerly used for these buffers. This, in turn, reduces the transmission frequency of each line and may allow either or both of the timing controller 115 and display electronics 110 to be more tolerant, operate at lower maximum frequencies, conserve power and/or employ less expensive circuitry.

The buffer may store one or more lines of raw image data 140, including the HBIs and VBI for each stored line. Such image data would be read into the buffer at the data's native frequency. When the data is retrieved from the buffer, either the timing controller 115 or the buffer 200 itself (or other electronic circuitry associated with the buffer) may strip or reduce the HBI at the end of each line stored in the line buffer and reformat the image data to spread this data across the time interval formerly required for the image data plus the HBI. That is, the buffer 200 or timing controller 115 may eliminate the HBI and reduce the frequency of the raw image data for each line to account for the HBI's absence. The re-timed image data 205 may be thus transmitted from an output of the buffer 200 to an input of the timing controller 115 at the adjusted frequency. In some embodiments, the buffer 200 may communicate with the timing controller across a system bus. In certain embodiments, the buffer may be integrated into the timing controller 115. The timing controller 15 may process the image data as necessary and transmit it to the display electronics 110 as processed image data 145, at the adjusted frequency.

Continuing the prior example, an embodiment having a line buffer 200 and removing all HBIs, but still operating at a 1900 by 1200 resolution and a 60 Hz refresh rate, would yield an operating frequency of:

(1920+0)×(1200+51)×60=144 MHz

This reduced operating frequency may be referred to herein as the “adjusted frequency” of the processed image data transmitted from the timing controller 115 to the display electronics 110 of the display 100. As can be seen from the foregoing, eliminating the HBIs from each line of image data may reduce the necessary operating frequency of the display electronics 110, and thus the display 100, by over 100 KHz. Likewise, if the operation or eliminating the HBIs is performed by the buffer itself or associated electronics, the timing controller 115 also may reduce its operating frequency as well as its maximum operating frequency.

In some embodiments, the buffer 200 may be a frame buffer instead of a line buffer. By using a frame buffer 200, an entire frame may be stored and the VBI at the end of each frame may be removed. Thus, the data of the frame may be spread across the interval formerly required for the frame plus the VBI, again yielding an adjusted frequency lower than the native frequency:

(1920+181)×(1200+0)×60=151 MHz

The use of a frame buffer therefore may have a similar effect as the use of a line buffer in reducing operating frequency and/or maximum operating frequency for the timing controller 115, display electronics 110 and/or display 100.

It should be noted that an embodiment employing a frame buffer 200 may remove not only the VBI from a frame of image data, but also the HBIs between each line of the frame. In such an embodiment, the adjusted frequency at the example operating parameters would become:

(1920+0)×(1200+0)×60=138 MHz

Alternately, an embodiment may employ both a line buffer and frame buffer to achieve the aforementioned results. For example, a line buffer may store every incoming line of data, remove the HBI therefrom, and transmit it to the frame buffer. The frame buffer may store all lines of image data (without the HBIs). The frame buffer may receive the VBI between frames but remove it and reformat the frame before transmitting it to the timing controller at the lower adjusted frequency.

It should be noted that a line buffer may either be of sufficient length to store only the image data and not the HBI associated with a line, or may store the HBI with the image data and be programmed to recognize the HBI in order to strip it out. The same is true with respect to a frame buffer and the VBI as well as, in some cases, the interspersed HBIs in the frame.

Generally, the storing, reformatting and transmission of image data at an adjusted frequency may implement some delay between generation of the data by the GPU and display of the data in the display area 105, because the data is being stored in the buffer prior to display. However, this delay may be relatively minimal. Presuming a frame buffer 200 is used, the delay induced by the buffer is equal to one cycle of the refresh rate of the display device 100. Thus, given a 60 Hz refresh rate, the delay in displaying the processed image data 145 is approximately 1/60^{th} of a second.

If a line buffer is used, the delay is even smaller since less data is stored prior to processing and display. For example, given the foregoing 1900 by 1200 resolution and a 60 Hz refresh rate, the delay induced by the line buffer 200 is about 1/72,000^{th} of a second (e.g., the time taken to draw one of 1200 lines in 1/60^{th} of a second).

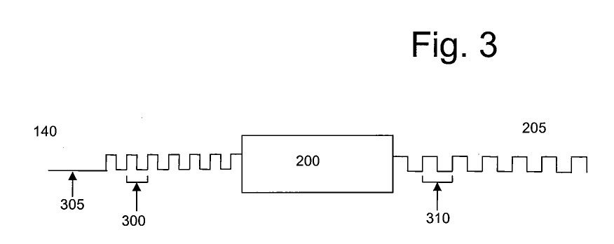

FIG. 3 is a timing diagram generally depicting a sample relationship between raw image data 140 inputted into a buffer 200 and the re-timed image data. Raw image data 140 may be read into the buffer 200 at a first frequency. This image data may include a blanking interval 305, which may be an HBI or VBI depending on the implementation of the buffer 200. In the present example, the blanking interval 305 represents an HBI and the raw image data 140 represents a line of data for display on the display device 100.

The raw image data 140 includes a number of pixel data, each such datum included in a single period 300 of the overall image data. For example, seven periods 300, and thus seven sets of pixel data, are shown in FIG. 3 in the sample line of raw image data. It should be understood that an actual line of raw image data will contain pixel data for many more than seven pixels; the example of FIG. 3 is provided for clarity and simplicity. The discussion herein may be applied to a line with any number of pixel data or a frame with any number of lines. Further, the blanking interval 305 may occur before or after the pixel data.

The raw image data 140 corresponding to a single line of the display area 105, including the HBI, is read into the buffer at the native frequency. The buffer 200 (or the timing controller 115) determines the time taken to receive the line, removes the HBI 305 from the line, and reformats the seven instances of pixel data to occupy the same length of time. Thus, the period 310 of each pixel datum in the re-timed image data 205 is transmitted at a lower frequency (e.g., is spread across a greater time) than the same pixel datum in the raw image data 140. Since the frequency of the re-timed image data 205 is lower than the frequency of the raw image data 140, the display electronics 110 of the display 105 may operate at a lower frequency and, in many cases, may have a lower maximum operating frequency. Alternately, the same display electronics 110 as used in a current display may continue to be used, but may handle higher resolutions and/or refresh rates than may be possible in current display devices 100.

It should be noted that similar operations may be used to eliminate the VBI between frames. For example, each period 300/310 may represent a single line of data rather than a single pixel datum and the blanking interval 305 may be a VBI. It should also be noted that embodiments may reduce the size of either or both of the HBI and VBI, rather than eliminating either or both entirely.

In some embodiments, most or all of the aforementioned elements may be integrated into a single device. For example, a portable audiovisual player may have a housing at least partially enclosing the GPU, timing controller, buffer, display electronics and display area to provide a single, integrated device encompassing certain functionality described herein. Likewise a portable computing device such as a notebook computer may likewise provide such functionality in a single device.

Although certain embodiments have been described herein with respect to particular physical implementations and modes of operation, it should be understood that these embodiments may be modified without departing from the spirit or scope of the invention.

What is claimed is:

1. An apparatus for changing a frequency of an image data stream, comprising:
a timing controller;
a buffer operably connected to the timing controller; wherein
the buffer accepts the image data stream at a first frequency;
the buffer transmits the image data stream to the timing controller; and
the timing controller outputs the image data stream at a second frequency that is lower than the first frequency.

2. The apparatus of claim 1, wherein:
the image data stream comprises:
a blanking interval; and
a data portion;
the buffer removes the blanking interval from the image data stream; and
the buffer adjusts the frequency of the data portion such that the data portion occupies a time equal to that of the blanking interval plus the data portion prior to adjustment.

3. The apparatus of claim 2, wherein:
the blanking interval is a horizontal blanking interval; and
the data portion is a line of image data for display on a row of a display device.

4. The apparatus of claim 2, wherein:
the blanking interval is a vertical blanking interval; and
the data portion is a frame of image data.

5. The apparatus of claim 1, wherein the buffer is integrated with the timing controller.

6. The apparatus of claim 5, further comprising:
display electronics operative to receive the image data stream at the second frequency from the timing controller; and
a display area operably connected to the display electronics.

7. The apparatus of claim 5, further comprising a graphics processing unit operative to output the image data stream at the first frequency; wherein
the timing controller accepts the input data stream at the first frequency from the graphics processing unit and transmits the input data stream to the buffer.

8. The apparatus of claim 7, further comprising:
display electronics operative to receive the image data stream at the second frequency from the timing controller;
a display area operably connected to the display electronics; and
a housing at least partially enclosing the graphics processing unit, timing controller, buffer, display electronics, and display area.

9. The apparatus of claim 5, further comprising a graphics processing unit operative to output the image data stream at the first frequency; wherein
the buffer accepts the input data stream at the first frequency from the graphics processing unit and transmits the input data stream to the timing controller.

10. A method for adjusting a frequency of a digital data stream, comprising:
receiving the digital data stream at a first frequency;
storing at least a portion of the digital data stream;
determining an initial length of the digital data stream;
determining a portion of the digital data stream containing no data;
separating the digital data stream into a portion containing no data and a remainder of the digital data stream;
expanding the remainder of the digital data stream to fit the initial length by lowering the frequency of the remainder of the digital data stream to a lowered frequency; and
outputting the remainder of the digital data stream, without the portion of the digital data stream containing no data, at the lowered frequency as an outputted data stream.

11. The method of claim 10, wherein:
the portion containing no data is a blanking interval; and
the remainder of the digital data stream is image data.

12. The method of claim 11, wherein:
the blanking interval is a horizontal blanking interval; and
the remainder of the digital data stream is a line of image data.

13. The method of claim 11, wherein:
the blanking interval is a vertical blanking interval.

14. The method of claim 11, wherein the operation of storing at least a portion of the digital data stream comprises:
storing an entirety of the digital data stream in a buffer, the buffer sized to store both the portion containing no data and the remainder of the digital data stream.

15. The method of claim 14, wherein the operation of separating the digital data stream comprises:
searching for a beginning of the blanking interval; and
removing the blanking interval from the buffer.

16. The method of claim 10, further comprising:
receiving, by display electronics, the outputted data stream at the lowered frequency; and
processing the outputted data stream for visual display.

17. The method of claim 16, wherein the outputted data stream comprises a frame for visual display.

18. The method of claim 17, wherein the frame is a portion of a video.

19. The method of claim 11, wherein the lowered frequency is dependent on a resolution and refresh rate of an associated display.

20. The method of claim 19, wherein the lowered frequency is calculated by multiplying a number of lines of resolution by a number of columns of resolution to yield a resolution product, which is multiplied by the refresh rate.
